(19) United States
(12) Patent Application Publication
(10) Pub. No.: US 2026/0049008 A1
(43) Pub. Date: Feb. 19, 2026

(54) ELECTROCHEMICAL WATER PURIFIERS WITH POROUS PARTICLE-BASED ELECTRODES

(71) Applicant: Yiming SU, Logan, UT (US)

(72) Inventor: Yiming SU, Logan, UT (US)

(73) Assignee: Utah State University, Logan, UT (US)

(21) Appl. No.: 19/276,336

(22) Filed: Jul. 22, 2025

Related U.S. Application Data
(60) Provisional application No. 63/683,315, filed on Aug. 15, 2024.

(51) Int. Cl. C02F 1/461; C02F 1/463; C02F 1/469; C02F 101/36; C02F 103/06

(52) U.S. Cl. CPC C02F 1/46114; C02F 1/463; C02F 1/469; C02F 2001/46133; C02F 2001/46161; C02F 2101/36; C02F 2103/06; C02F 2201/4616

(57) ABSTRACT

An electrochemical water purifier can include a water flow channel that includes a flow path for water to be treated. An electrochemical cell can be in the water flow channel. The electrochemical cell can include a first porous electrode that includes metal-containing particles. The metal-containing particles can include iron, zinc, nickel, or a combination thereof. The electrochemical cell can also include a second porous electrode that includes carbon-containing particles. The flow path can extend through the first porous electrode and the second porous electrode. A voltage source can be electrically connected to apply a voltage across the first porous electrode and the second porous electrode.

### CROSS REFERENCE TO RELATED APPLICATIONS

This application claims priority to U.S. Provisional Patent Application No. 63/683,315, filed on Aug. 15, 2024, which is hereby incorporated herein by reference.

### STATEMENT REGARDING FEDERALLY SPONSORED RESEARCH OR DEVELOPMENT

Not applicable.

### BACKGROUND

Emerging pollutants, such as per- and polyfluoroalkyl substances (PFAS), nanoplastics (NPs), along with heavy metals and pesticides, impose great risk on water quality of natural water bodies, particularly those used as raw water for drinking water supply systems. In rural areas, drinking water heavily depends on groundwater. However, groundwater often contains arsenic (As) and manganese (Mn). This indicates that further treatment is needed while currently there is a lack of cost-effective methods to reliably remove these inorganic pollutants. In addition, across the world, agricultural runoff containing nutrients, pesticides, and heavy metals, adds to many current water crises, such as algal bloom and spreading of the antibiotic resistance genes. The appearance of microplastics, nanoplastics, and PFAS in agricultural irrigation (from municipal wastewater treatment plants) water has added increasingly high risk on food security. There is an urgent need to develop a cost-effective method to process those large volumes of water, targeting effective removal of all these pollutants.

In addition, it has been widely acknowledged that chlorinated organic compounds in subsurface water are a health threat to humans. Some current technologies, such as pump-and-treat techniques, permeable reactive barriers, nanomaterial injection, and others can be expensive and not cost-effective. Other technologies, such as adsorption, coagulation-flocculation and advanced oxidation, cannot effectively remove all of these pollutants. Certain technologies, such as reverse osmosis and some nanotechnologies, although they may be capable of removing these emerging contaminants, are still too expensive for wide adoption due to the high membrane and nanomaterials cost and maintenance cost.

### SUMMARY

This disclosure describes electrochemical water purifiers, electrochemical water purification systems, and methods of purifying water. In one example, an electrochemical water purifier can include a water flow channel comprising a flow path for water to be treated. An electrochemical cell can be in the water flow channel. The electrochemical cell can include a first porous electrode comprising metal-containing particles. The metal-containing particles can include platinum, iron, zinc, aluminum, or a combination thereof. The electrochemical cell can also include a second porous electrode comprising carbon-containing particles. The flow path can extend through the first porous electrode and the second porous electrode. A voltage source can be electrically connected to apply a voltage across the first porous electrode and the second porous electrode.

An example electrochemical water purification system can include a water flow channel comprising a flow path for water to be treated. A first electrochemical cell can be in the water flow channel. The first electrochemical cell can comprise a positive metal-containing porous electrode comprising metal-containing particles and a negative carbon-containing porous electrode comprising carbon-containing particles. The flow path can extend through the positive metal-containing porous electrode and the negative carbon-containing porous electrode. A second electrochemical cell can also be in the water flow channel. The second electrochemical cell can comprise a negative metal-containing porous electrode comprising metal-containing particles and a positive carbon-containing porous electrode comprising carbon-containing particles. The flow path can extend through the negative metal-containing porous electrode and the positive carbon-containing porous electrode. One or more voltage sources can be connected to apply a voltage across the positive metal-containing porous electrode and the negative carbon-containing porous electrode, and to apply a voltage across the negative metal-containing porous electrode and the positive carbon-containing porous electrode.

An example method of purifying water can include flowing water comprising a contaminant through a first porous electrode of an electrochemical cell. The first porous electrode can comprise metal-containing particles, wherein the metal-containing particles comprise iron, zinc, nickel, or a combination thereof. The water can also flow through a second porous electrode of the electrochemical cell, wherein the second porous electrode comprises carbon-containing particles. A voltage can be applied across the first porous electrode and the second porous electrode. The contaminant can be removed from the water at the first porous electrode, at the second porous electrode, or a combination thereof.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

FIG. 1 is a schematic illustration of an example electrochemical water purifier in accordance with an example of the present technology.

FIG. 2 is a schematic illustration of an example electrochemical water purification system in accordance with an example of the present technology.

FIG. 3 is a schematic illustration of another example electrochemical water purifier in accordance with an example of the present technology.

FIG. 4 is a flowchart illustrating an example method of purifying water in accordance with an example of the present technology.

FIG. 5 is a graph of contaminant removal efficiency of an electrochemical water purification system in accordance with an example of the present technology.

These drawings are provided to illustrate various aspects of the invention and are not intended to be limiting of the scope in terms of dimensions, materials, configurations, arrangements or proportions unless otherwise limited by the claims.

### DETAILED DESCRIPTION

While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

### Definitions

In describing and claiming the present invention, the following terminology will be used.

The singular forms “a,” “an,” and “the” include plural referents unless the context clearly dictates otherwise. Thus, for example, reference to “a metal” includes reference to one or more of such materials and reference to “the electrode” refers to one or more of such electrodes.

As used herein with respect to an identified property or circumstance, “substantially” refers to a degree of deviation that is sufficiently small so as to not measurably detract from the identified property or circumstance. The exact degree of deviation allowable may in some cases depend on the specific context.

As used herein, the term “about” is used to provide flexibility and imprecision associated with a given term, metric or value. The degree of flexibility for a particular variable can be readily determined by one skilled in the art. However, unless otherwise enunciated, the term “about” generally connotes flexibility of less than 2%, and most often less than 1%, and in some cases less than 0.01%.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

As used herein, the term “at least one of” is intended to be synonymous with “one or more of.” For example, “at least one of A, B and C” and “at least one of A, B, or C” explicitly includes only A, only B, only C, or combinations of each.

Numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of about 1 to about 4.5 should be interpreted to include not only the explicitly recited limits of 1 to about 4.5, but also to include individual numerals such as 2, 3, 4, and sub-ranges such as 1 to 3, 2 to 4, etc. The same principle applies to ranges reciting only one numerical value, such as “less than about 4.5,” which should be interpreted to include all of the above-recited values and ranges. Further, such an interpretation should apply regardless of the breadth of the range or the characteristic being described.

Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given herein.

### Electrochemical Water Purifiers

The technology described herein can be used in water treatment systems targeting pollutants such as PFAS (polyfluoroalkyl substances), PPCPs (pharmaceuticals and personal care products), nanoplastics, and heavy metals. In these systems, water can be treated as it passes through electrochemical cells that can also act as filters. In certain examples, the electrochemical cells can include a carbon based electrode, an iron based electrode, and a coiled platinum coated titanium wire anode. As a voltage is applied to the coiled wire, the carbon electrode column can induce iron dissolution at the anode and electrocoagulation and electroadsorption at the cathode to remove nanoplastics and heavy metals. Additionally, the carbon electrode can be adjusted to enhance oxidation for the degradation of pesticides and PPCPs. With applied voltage, the iron electrode can induce a reducing environment with iron as the cathode and carbon as the anode to remove PFAS and nanoplastic/microplastic. The column can also be regenerated by reversing the applied polarity, thus the expelled ions can be recovered in a brine and the system can be used repeatedly.

The porous electrodes can be made from carbon-based materials and iron-based materials, respectively. In some examples, the carbon-based materials and iron-based materials can be particles with a size below 20 mesh size. Carbon-based materials can include granular activated carbon or other carbon particles, with relatively good conductivity. Iron-based materials can include pristine micron Fe⁰, sulfidated Fe⁰, Fe₃O₄ coated Fe⁰, silicate coated Fe⁰ or phosphate coated Fe⁰. The particles can be placed into 376×376 mesh Nylon film, and within the particle electrodes there can be a coiled platinum-coated titanium wire to conduct electrons. In this way, the electrodes in columns can be easily replaced with new electrodes. The volume of the materials in the electrodes can depend on the physical-chemical properties of pollutants to be removed, water quality, and targeted removal performance. In the case of groundwater remediation, the electrodes can be placed into a horizontal channel.

In some examples, the system can include two electrochemical cells. The first cell can induce controlled Fe⁰ dissolution at the anode and stimulate coagulation and electro-adsorption at cathode. The controlled Fe dissolution can be realized by adjusting the overall cell potential. The system can also incorporate advanced oxidation into this stage through aerating the influent. The first electrochemical cell can be efficient for removing nanoplastics and heavy metals through both electrocoagulation and electroadsorption. The first electrochemical cell can also be operated in a way to provide advanced oxidation, which can be useful for pesticides and pharmaceuticals degradation.

The system can also include a second electrochemical cell, which can include similar carbon-based and iron-based electrodes as the first electrochemical cell, but with the polarity reversed so that the iron-based electrode is negatively charged instead of positively charged as in the first cell, and the carbon-based electrode can be positively charged instead of negatively charged as in the first cell. The second electrochemical cell can be used to induce reducing environment through using Fe⁰ as cathode and carbon-based materials as anode. This can be efficient for converting nitrate to ammonium (on cathode) and in the presence of chloride (which can be converted to chlorine), ammonium can be further converted to N₂ (on anode). Since the carbon-based electrode can have a high surface area, good surface hydrophobicity and a positive charge, this process can be tuned for removing PFAS, which have a hydrophobic carbon chain and a negatively charged head. Additionally, a sufficient voltage can be applied in the first cell, the second cell, or both to kill pathogens.

In a particular example, an electrochemical water purifier can include a water flow channel comprising a flow path for water to be treated. An electrochemical cell can be in the water flow channel. The electrochemical cell can include a first porous electrode comprising metal-containing particles. The metal-containing particles can include platinum, iron, zinc, aluminum, or a combination thereof. The electrochemical cell can also include a second porous electrode comprising carbon-containing particles. The flow path can extend through the first porous electrode and the second porous electrode. A voltage source can be electrically connected to apply a voltage across the first porous electrode and the second porous electrode.

In some examples, the water flow channel can include a packed column. In other examples, the water flow channel can include a channel formed underground and the water to be treated can be groundwater. In some cases, the flow path can include a natural groundwater flow path.

The first porous electrode can be positively charged and the second porous electrode can be negatively charged in some examples. In other examples, the first porous electrode can be negatively charged and the second porous electrode can be positively charged. The first porous electrode can be upstream of the second porous electrode with respect to the flow path.

In some examples, the metal-containing particles can include Fe⁰, sulfidated Fe⁰, Fe₃O₄-coated Fe⁰, silicate coated Fe⁰, phosphate-coated Fe⁰, or a combination thereof. In further examples, the carbon-containing particles can include granular activated carbon (GAC), and surface modified GAC (including nanoscale metal doping, such as Fe, Zn), carbon black (CB), graphite (G), and a mixture of carbon materials, such as carbon nanotube or reduced graphene oxide with GAC, CB and/or G. The metal-containing particles and the carbon-containing particles can have a particle size less than 20 mesh. In some examples, the voltage source can be connected to the first and second porous electrodes by a coiled wire embedded in the first and second porous electrodes. The coiled wire can include platinum-coated titanium wire or Pt wire. The electrochemical water purifier can also include one or more porous supporting layers retaining the first porous electrode and the second porous electrode within the water flow channel. The one or more porous supporting layers can comprise a 376×376 mesh film.

In some examples, the voltage source can be configured to apply a voltage from 0 V to 20 V across the first porous electrode and the second porous electrode. In further examples, the electrochemical water purifier can also include an aerator upstream of the electrochemical cell to aerate influent water to be treated.

In another example, an electrochemical water purification system can include a water flow channel comprising a flow path for water to be treated. A first electrochemical cell can be in the water flow channel. The first electrochemical cell can comprise a positive metal-containing porous electrode comprising metal-containing particles and a negative carbon-containing porous electrode comprising carbon-containing particles. The flow path can extend through the positive metal-containing porous electrode and the negative carbon-containing porous electrode. A second electrochemical cell can also be in the water flow channel. The second electrochemical cell can comprise a negative metal-containing porous electrode comprising metal-containing particles and a positive carbon-containing porous electrode comprising carbon-containing particles. The flow path can extend through the negative metal-containing porous electrode and the positive carbon-containing porous electrode. One or more voltage sources can be connected to apply a voltage across the positive metal-containing porous electrode and the negative carbon-containing porous electrode, and to apply a voltage across the negative metal-containing porous electrode and the positive carbon-containing porous electrode.

In some examples, the first electrochemical cell can be upstream of the second electrochemical cell with respect to the flow path. In further examples, the positive metal-containing porous electrode can be upstream of the negative carbon-containing porous electrode. In other examples, the negative metal-containing porous electrode can be upstream of the positive carbon-containing porous electrode. The water flow channel can include one or more packed columns certain examples. In other examples, the water flow channel can include one or more channels formed underground and the water to be treated can be groundwater.

In some examples, the metal-containing particles can comprise platinum, iron, zinc, aluminum, or a combination thereof. In certain examples, the metal-containing particles can comprise Fe⁰, sulfidated Fe⁰, Fe₃O₄-coated Fe⁰, silicate coated Fe⁰, phosphate-coated Fe⁰, or a combination thereof. The carbon-containing particles can comprise granular activated carbon in some examples.

The one or more voltage sources can allow independent control of the voltage across the positive metal-containing porous electrode and the negative carbon-containing porous electrode, and the voltage across the negative metal-containing porous electrode and the positive carbon-containing porous electrode, in certain examples. The one or more voltages sources can be configured to apply a voltage from 0 V to 10 V across the positive metal-containing porous electrode and the negative carbon-containing porous electrode, and to apply a voltage from 0 V to 20 V across the negative metal-containing porous electrode and the positive carbon-containing porous electrode. In further examples, the system can also include an aerator upstream of the first electrochemical cell to aerate influent water to be treated.

An example method of purifying water can include flowing water comprising a contaminant through a first porous electrode of an electrochemical cell. The first porous electrode can comprise metal-containing particles, wherein the metal-containing particles comprise iron, zinc, nickel, or a combination thereof. The water can also flow through a second porous electrode of the electrochemical cell, wherein the second porous electrode comprises carbon-containing particles. A voltage can be applied across the first porous electrode and the second porous electrode. The contaminant can be removed from the water at the first porous electrode, at the second porous electrode, or a combination thereof.

In certain examples, the water can flow through the first porous electrode first, followed by flowing through the second porous electrode. In further examples, the first porous electrode can be positively charged and the second porous electrode can be negatively charged. The method can also include flowing the water through a third porous electrode and a fourth porous electrode and applying a voltage across the third porous electrode and the fourth porous electrode. The third porous electrode can comprise metal-containing particles and can be negatively charged, and the fourth porous electrode can comprise carbon-containing particles and can be positively charged. In other examples, the first porous electrode can be negatively charged and the second porous electrode can be positively charged.

In some examples, the contaminant can include a polyfluoroalkyl substance (PFAS), a pathogen, a pharmaceutical, a nitrate, a heavy metal, a pesticide, a microplastic, a nanoplastic, or a combination thereof. In certain examples, the contaminant can be removed by electrocoagulation, electroadsorption, oxidation, reduction, or a combination thereof. The method can also include aerating the water before flowing the water through the first porous electrode. In certain examples, the metal-containing particles can comprise iron and the method can also include dissolving iron at the first porous electrode and removing the contaminant at the second porous electrode by electrocoagulation or electroadsorption. In other examples, the contaminant can comprise a nitrate, and the method can include converting the nitrate to ammonium at the first porous electrode and converting the ammonium to N₂ at the second porous electrode. In still further examples, the contaminant can include a polyfluoroalkyl substance (PFAS) and the PFAS can be removed by electroadsorption at the second porous electrode.

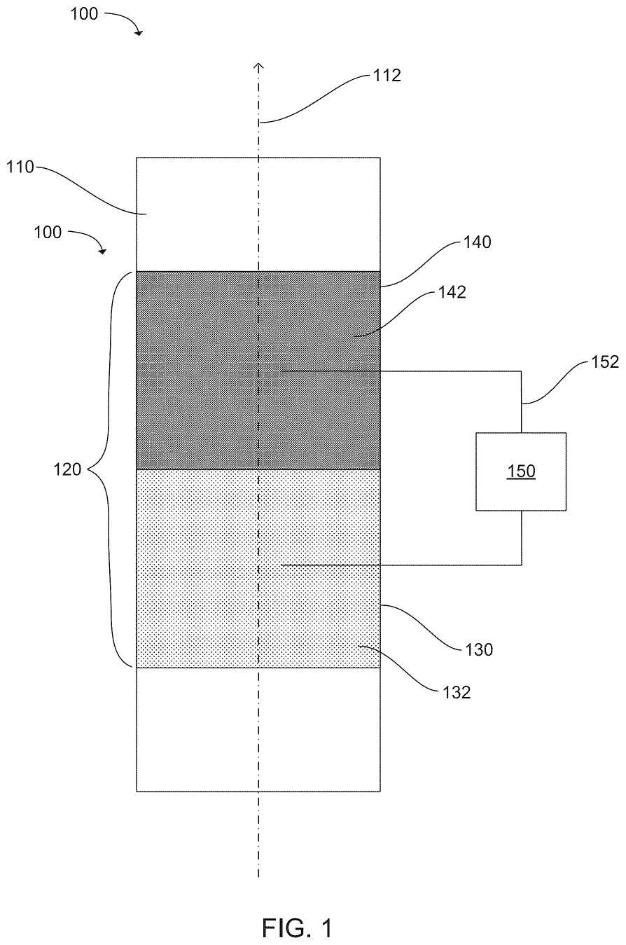

FIG. 1 shows a schematic view of an example electrochemical water purifier 100. This example includes a water flow channel 110 that includes a water flow path 112 for water to be treated. An electrochemical cell 120 is in the water flow channel. The electrochemical cell includes a first porous electrode 130 comprising metal-containing particles 132. The metal-containing particles can include platinum, iron, zinc, aluminum or a combination thereof. The electrochemical cell also includes a second porous electrode 140 comprising carbon-containing particles 142. The water flow path extends through the first porous electrode and the second porous electrode. A voltage source 150 is electrically connected by wires 152 to the first and second porous electrodes to apply a voltage across the first and the second porous electrodes.

The electrochemical water purifiers described herein can include a single electrochemical cell as shown in FIG. 1, in some examples. The first porous electrode and the second porous electrode can be positioned in series with respect to the water flow path so that the water flows through the first porous electrode (having the metal-containing particles) and then through the second porous electrode (having the carbon-containing particles). In other examples, the water can flow in the opposite direction and flow through the second porous electrode followed by the first porous electrode. In certain examples, the water can flow through the first porous electrode followed by the second porous electrode when the cell is being used to purify the water, but the cell can be regenerated by flowing water in the reverse direction to wash contaminants out of the cell. Additionally, the polarity of the voltages applied to the cell can be reversed when the cell is being regenerated in some examples.

The voltage source can be connected to the first and second porous electrodes to apply opposite charges to the electrodes. For example, the first porous electrode can have a positive charge and the second porous electrode can have a negative charge. In a different example, the first porous electrode can have a negative charge and the second porous electrode can have a positive charge. Both of these arrangements can be useful for purifying water depending on the specific contaminants that are to be removed from the water. In one example, the first porous electrode can be used as an anode (positively charged) and the second porous electrode can be used as a cathode (negatively charged). This example can be useful for removing heavy metals and nanoplastics. In certain examples, heavy metals and nanoplastics can be removed from the water by electrocoagulation and electroadsorption on the negatively charged carbon-containing particles of the second porous electrode. In another example, the first porous electrode can be a negatively charged cathode and the second porous electrode can be a positively charged anode. In this example, come contaminants can be reduced at the first porous electrode, such as nitrates, which can be reduced to form ammonium. The ammonium can then be converted to N₂ at the second porous electrode. The positively charged carbon-containing particles in this example can also be useful to remove PFAS from the water because the negatively charged head of the PFAS. Thus, the electrochemical water purifier can have either arrangement of positive and negative polarity, with each arrangement being useful for removing different contaminants.

In further examples, two electrochemical cells can be placed in series with respect to the flow of water. In other words, the water can flow through a first electrochemical cell and then flow through a second electrochemical cell. The two electrochemical cells can be set up with opposite polarities. For example, the first electrochemical cell can have a positive first (metal-containing) porous electrode and a negative second (carbon-containing) porous electrode. Then, the second electrochemical cell can have a negative first (metal-containing) electrode and a positive second (carbon-containing) electrode. Each of the electrochemical cells in this example can remove different contaminants from the water. For example, heavy metals and nanoplastics can be removed in the first electrochemical cell, while nitrates and PFAS can be removed in the second electrochemical cell.

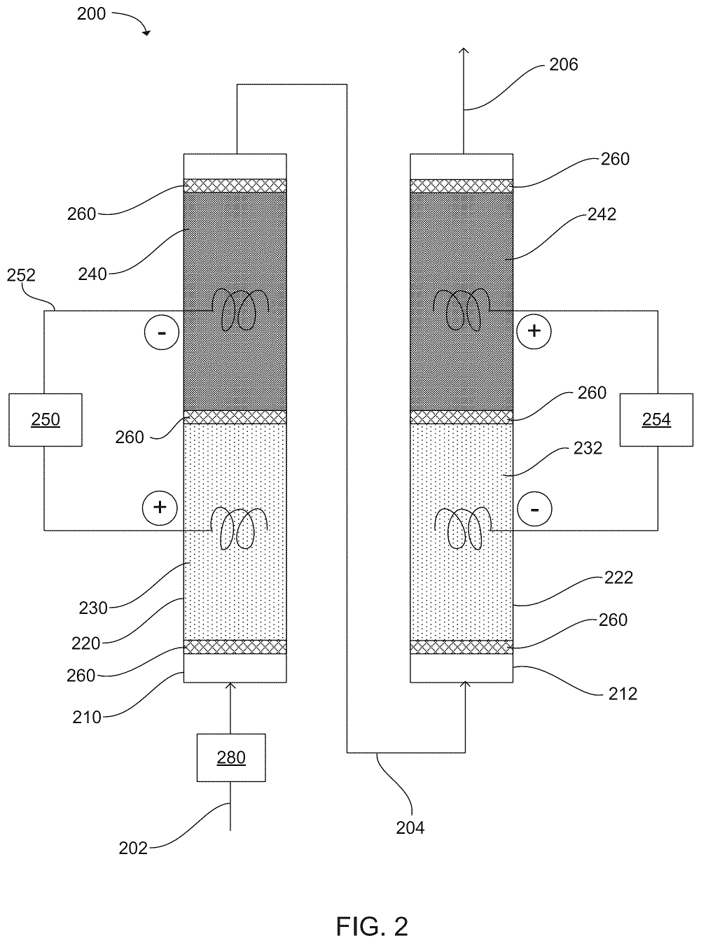

FIG. 2 shows a schematic view of an electrochemical water purification system 200 that includes two electrochemical cells 220, 222 set up in this way. This example system also includes an aerator 280 to aerate the water before the water flows through the electrochemical cells. A first electrochemical cell 220 has a first porous electrode 230 made up of iron-containing particles, which are positively charged. The second porous electrode 240 of the first cell is made up of carbon-containing particles, which are negatively charged. In this example, the particles are packed in a packed column 210 with supporting layers 260 positioned to keep the particles in place. A voltage source 250 is electrically connected to the first porous electrode and second porous electrode by coiled wires 252 in order to provide a voltage that provides the positive charge to the first porous electrode and a negative charge to the second porous electrode. In this example, water flows into the packed column through an inlet stream 202 that passes through the aerator. After water flows through the first electrochemical cell, the water flows through an intermediate stream 204 into a second packed column 212 containing a second electrochemical cell 222. The electrodes in the second cell have opposite charges from the first cell. In the second cell, the first porous electrode 232 is made up of iron-containing particles just as in the first cell, but the iron-containing particles are negatively charged in the second cell. The second porous electrode 242 of the second cell is made up of carbon-containing particles that are positively charged. The second electrochemical cell is connected to a second voltage source 254 by coiled wires. In this example, the first electrochemical cell and the second electrochemical are connected to separate power supplies to provide the voltage across the electrodes. After flowing through the second packed column, treated water flows out through an effluent stream 206. Thus, the water flow path in this system begins at the inlet stream, then flows through the first packed column, through the intermediate stream, through the second packed column, and out through the effluent stream.

In some examples, the electrochemical water purifiers and systems can include packed columns, where the particles making up the electrodes are packed in the packed columns. When two or more electrochemical cells are included in a system, the electrochemical cells can each be in separate packed columns, or multiple electrochemical cells can be packed in a single column. The water flow path can be such that the water flows through the multiple electrochemical cells in series. Multiple electrochemical cells can be used with the same voltage applied to each electrochemical cell, or different voltages can be applied to different electrochemical cells. In some examples, the voltage applied to each cell can be tuned to facilitate removal of specific contaminants, which may be different for each cell.

In some examples, additional material layers can be included in the packed columns. For example, one or more sand layers can be included. A sand layer can be placed beneath the electrochemical cell, above the electrochemical cell, or inside the electrochemical cell. In certain examples, a sand layer can be located between the first porous electrode and the second porous electrode to separate the conductive electrode materials of the two electrodes. In further examples, a sand layer can be beneath the electrochemical cell to support the conductive electrode materials.

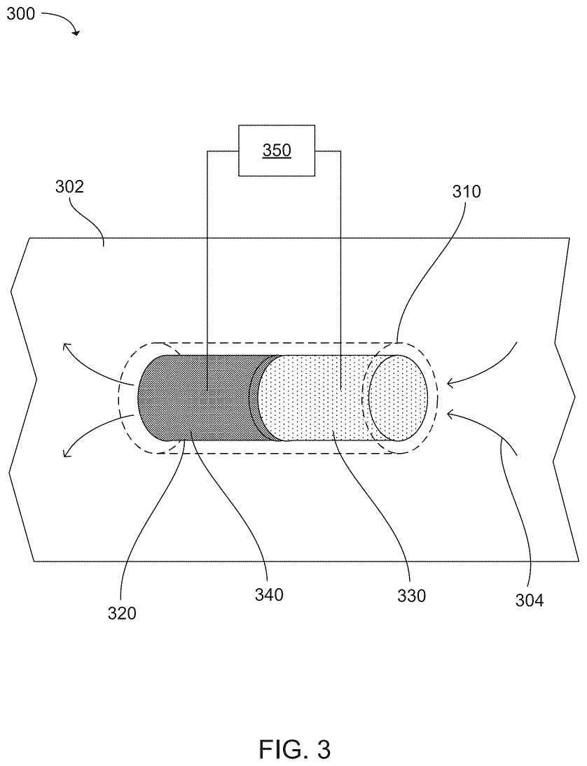

The electrochemical water purifiers and systems described herein can also be used to treat groundwater directly underground. FIG. 3 shows an example electrochemical water purifier 300 formed in an underground channel 310. The underground channel can be dug out in the earth 302, such as a cylindrical channel or a channel having any other shape. In some examples, the channel can be formed with walls of the naturally present rock or soil. In other examples, the channel can include a casing such as a pipe or tube. The channel can be filled with metal-containing particles and carbon-containing particles. The metal-containing particles can form a first porous electrode 330 and the carbon-containing particles can form a second porous electrode 340. The first and second porous electrodes together make up an electrochemical cell 320. The first and second porous electrodes can be connected to a voltage source 350 to apply a voltage across the electrodes underground. In some examples, the voltage source can be above ground, and can be connected to the underground electrodes by cables. In other examples, the voltage source can be underground with the electrochemical cell. Groundwater can flow through the electrochemical cell as indicated by arrows 304, and can be treated directly underground, and contaminants in the water can be removed by the porous electrodes. The underground system can include a single electrochemical cell or two electrochemical cells in series, with first and second porous electrodes having opposite polarities as described above. If more than one electrochemical cell is used, the multiple electrochemical cells can be placed together in a single underground channel or the cells can be placed in separate channels.

In some cases, these systems can be used to treat groundwater without pumping the groundwater. For example, the electrochemical water purifier can be formed in an underground channel that is dug in a location that experiences natural flow of groundwater. Then, the groundwater can flow through the electrochemical cell just as it normally would flow through the underground soil or rock. In other examples, groundwater can be pumped through the water flow channel or forced through the water flow channel by injecting water through an injection well, recovering water at a recovery well, or a combination thereof.

The size of the flow channel can depend on the volume of water to be purified and the amount of contaminants to be removed. In some examples, a packed column can be used that has a diameter from a few centimeter to several meters, such as from 1 cm to 5 m, or from 5 cm to 2 m, or from 5 cm to 1 m, or from 5 cm to 50 cm, or from 5 cm to 20 cm, or from 1 cm to 20 cm, or from 20 cm to 5 m, or from 20 cm to 2 m, or from 20 cm to 1 m, or from 20 cm to 50 cm, or from 50 cm to 5 m, or from 50 cm to 2 m, or from 50 cm to 1 m, or from 1 m to 5 m, or from 1 m to 2 m, or from 2 m to 5 m. In other examples, an underground channel can be used having any of the above diameters.

The volume of particles used to form the porous electrodes can also depend on the amount of water to be treated and the amount of contaminants to be removed. The particles making up the porous electrodes can provide high surface area to allow for adsorption, electroadsorption, dissolution of metal such as iron from the particles into the water, and other useful effects. The particles can also have small void spaces between the particles that act as a size exclusion filter. In some examples, the electrochemical water purifier can be used until the amount of contaminants trapped in the porous electrodes reaches a saturation level or other threshold level, and then the electrochemical water purifier can be regenerated. various sizes of electrochemical water purifiers can have porous electrodes that include a volume of particles from 10 cm³ to 50 m³, or from 10 cm³ to 10 m³, or from 10 cm³ to 1 m³, or 10 cm³ to 50 cm³, or from 50 cm³ to 50 m³, or from 50 cm³ to 10 m³, or from 50 cm³ to 1 m³, or 1 m³ to 50 m³, or from 1 m³ to 10 m³, or from 10 m³ to 50 m³.

As used herein, the “first” porous electrode refers to a porous electrode that includes metal-containing particles. In some examples, the metal-containing particles can contain platinum, iron, zinc, aluminum, or a combination thereof. In certain examples, the metal-containing particles can contain zero-valent iron (Fe⁰), sulfidated Fe⁰, Fe₃O₄-coated Fe⁰, silicate coated Fe⁰, phosphate-coated Fe⁰, or a combination thereof. The particle size of the metal-containing particles can be 20 mesh or smaller in some examples.

As used herein, the “second” porous electrode refers to a porous electrode that includes carbon-containing particles. In certain examples, the carbon-containing particles can include granular activated carbon, glassy carbon, carbon fibers/cloth/felt, graphite, graphene, carbon nanotubes, graphene oxide (GO) and reduced graphene oxide. The particle size of the carbon-containing particles can be 20 mesh or smaller in some examples.

The electrochemical water purifier can include a voltage source connected to the electrodes to apply a voltage across the electrodes. In some examples, the voltage source can be connected to the first porous electrode and/or the second porous electrode by a coiled wire embedded in the first and/or second porous electrode. In other examples, the voltage source can be connected to the first and/or second porous electrode by a wire with multiple branches that spread apart throughout the particles of the first and/or second porous electrode. The wire connecting the voltage source to the porous electrodes can be configured to provide sufficient contact area between the wire and the particles of the porous electrodes to transfer the applied voltage to the particles. In certain examples, the wire can be a titanium or platinum wire. In further examples, the titanium wire can be coated with platinum.

In some examples, the voltage applied between the positive porous electrode and the negative porous electrode can be from about 0 V to about 20 V, or from about 0 V to about 15 V, or from about 0 V to about 10 V, or from about 0 V to about 5 V, or from about 5 V to about 10 V, or from about 10 V to about 15 V, or from about 15 V to about 20 V. The electric current passing through the electrodes can vary depending on several factors, including the concentration of contaminants in the water, the conductivity of the water, the volumetric flow rate of water through the electrochemical water purifier, the volume of the porous electrodes, and the overall design of the electrochemical cell. Typically, the process can consume 1 mA to 200 mA.

The electrochemical water purifier can also include supporting layers to retain the particles of the first porous electrode and the second porous electrode. The supporting layers can prevent the particles from washing out of the water flow channel. The supporting layers can comprise a porous material such as a porous mesh or membrane. In some examples, the supporting layers can include a 200 mesh film or a mesh film having smaller pores. Smaller mesh sizes that can be used include 300 mesh, 400 mesh, 500 mesh, and smaller. Larger mesh sizes can also be used as supporting layers in some examples, such as smaller than 20 mesh, or 40 mesh or smaller, 50 mesh or smaller, 100 mesh or smaller, or 150 mesh or smaller. In various examples, the supporting layer can have a pore size that is smaller than a particle size of the first porous electrode or the second porous electrode. Filter membranes can be used as the supporting layer in other examples. In certain examples, a supporting layer can be positioned between the first porous electrode and the second porous electrode to separate the first and second porous electrodes. In further examples, a supporting layer can be positioned upstream of the first porous electrode, downstream of the second porous electrode, or both. In further examples, supporting layers can be used in conjunction with sand layers, such as to separate a sand layer from the porous electrode materials, or to retain a sand layer inside the electrochemical water purifier.

An aerator can also be included in the electrochemical water purifier. The aerator can introduce air into the water to facilitate advanced oxidation of contaminants in the water. In some examples, the aerator can be upstream of the first porous electrode, upstream of the second porous electrode, or the aerator can be configured to inject air directly into the first porous electrode and/or the second porous electrode. The aerator can be configured to provide an elevated concentration of oxygen in the water. In some examples, the aerator can provide a dissolved oxygen concentration from about 5 ppm to about 15 ppm. In certain examples, the aerator can inject air, oxygen-enriched air, or pure oxygen. In further examples, the aerator can inject more reactive oxidizing species such as ozone.

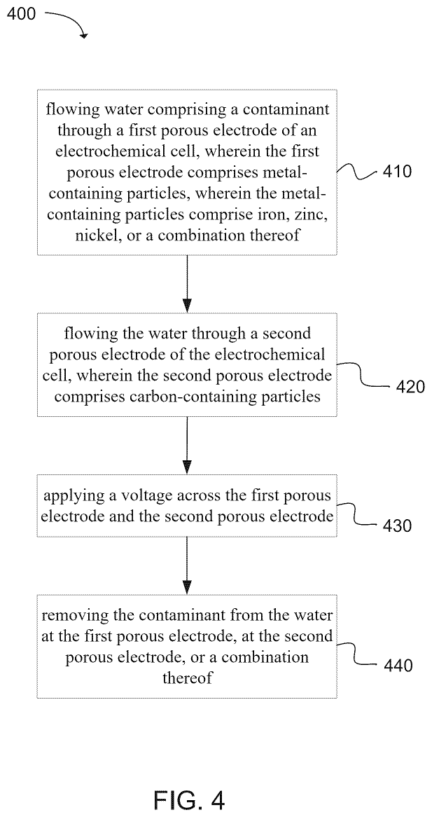

The present disclosure also describes methods of purifying water. FIG. 4 is a flowchart illustrating an example method 400 of purifying water. The method includes: flowing water comprising a contaminant through a first porous electrode of an electrochemical cell, wherein the first porous electrode comprises metal-containing particles, wherein the metal-containing particles comprise iron, zinc, nickel, or a combination thereof 410; flowing the water through a second porous electrode of the electrochemical cell, wherein the second porous electrode comprises carbon-containing particles 420; applying a voltage across the first porous electrode and the second porous electrode 430; and removing the contaminant from the water at the first porous electrode, at the second porous electrode, or a combination thereof 440.

In various examples, the water can flow through the first porous electrode first, followed by flowing through the second porous electrode. Alternatively, the water can flow through the second porous electrode first, followed by flowing through the first porous electrode. The first porous electrode can be positively charged and the second porous electrode can be negatively charged. In alternative examples, the first porous electrode can be negatively charged and the second porous electrode can be positively charged. In a particular example, the water can flow through a positively charged first electrode, then a negatively charged second electrode, then a negatively charged third electrode that comprises metal-containing particles, then a positively charged fourth electrode that comprises carbon-containing particles.

The flow rate of water through the electrochemical cell can be selected to provide sufficient time for contaminants to be removed by oxidation, reduction, electrocoagulation, electroadsorption, or a combination thereof. In some examples, the water can flow through the electrochemical cell at a flow rate such that an amount of water equivalent to the combined pore volume of the porous electrodes flows through the cell in a time from about 1 minute to about 20 minutes. In other examples, a pore volume of water can flow through the cell in a time from about 1 minute to about 10 minutes, or from about 1 minute to about 5 minutes, or from about 5 minutes to about 10 minutes, or from about 10 minutes to about 15 minutes, or from about 10 minutes to about 20 minutes.

The methods can include removing any of the contaminants described above, such as a polyfluoroalkyl substance (PFAS), a pathogen, a pharmaceutical, a nitrate, a heavy metal, a pesticide, a microplastic, a nanoplastic, or a combination thereof. The category of PFAS includes a large number of individual compounds. Some example PFAS that can be removed include fluorinated surfactants, perfluorooctane sulfonic acid, perfluorooctonoic acid, perfluorononanoic acid, trifluoroacetic acid, other perfluoroalkyl acids, and many others. Example pathogens that can be removed using the methods described herein include bacteria, viruses, protozoa, such as Giardia, Cryptosporidium, Salmonella, E. coli, SARS-CoV-2, and others. Example pharmaceuticals that can be removed include analgesics, anti-inflammatories, antibiotics, hormones, antidepressants, and others. Example heavy metals that can be removed include lead, arsenic, cadmium, manganese, mercury, chromium, zinc, copper, nickel, and others.

The contaminants can be removed by electrocoagulation, electroadsorption, oxidation, reduction, or a combination thereof. Electrocoagulation can refer to using the electric charge of the porous electrodes to destabilize a contaminant, causing molecules or particles of the contaminant species to clump together and form larger particles that will become stuck in the porous electrode material. Electroadsorption can refer to the use of electric charge to attract contaminant species to the surface of particles of the porous electrode materials, where the contaminant can be adsorbed to the surface and thereby retained by the porous electrode materials. Oxidation and reduction can refer to subjecting the contaminant species to a chemical reduction in which the contaminant species is oxidized or reduced, which can convert the contaminant into a non-harmful compound and/or convert the contaminant into another material that can be more easily separated from the water. In certain examples, the metal-containing particles can comprise iron, and the method can include dissolving iron at the first porous electrode and removing the contaminant at the second porous electrode by electrocoagulation or electroadsorption. In other examples, the contaminant can comprise a nitrate, and the method can include converting the nitrate to ammonium at the first porous electrode and converting the ammonium to N₂ at the second porous electrode. In still further examples, the contaminant can comprise a polyfluoroalkyl substance (PFAS) and the PFAS can be removed by electroadsorption at the second porous electrode.

In further examples, the method can include regenerating the porous electrodes. Regeneration can be accomplished by flowing water through the porous electrodes, and in some examples the water can flow in the opposite direction as when the electrochemical cell is being used for water decontamination. Additionally, in some examples the polarity of the porous electrodes can be reversed during regeneration, by applying an opposite voltage to the porous electrodes compared to the voltage applied during water decontamination. This can cause some adsorbed contaminants to be repelled by the porous electrode material, making the contaminants easy to remove from the porous electrodes.

### EXAMPLES

An electrochemical water purification system was prepared with the design shown in FIG. 2 except that no aerator was included in the system. Two columns were packed with iron particles and carbon particles such that the iron particles formed a first porous electrode and the carbon particles formed a second porous electrode. In the first column, the iron particles were connected to the positive side of a power supply and the carbon particles were connected to the negative side of the power supply. In the second column, the iron particles were connected to the negative side of a second power supply, and the carbon particles were connected to the positive side of the second power supply. The columns were connected with tubing so that water flowed through the iron particles in the first column, followed by the carbon particles in the first column, followed by the iron particles in the second column, followed by the carbon particles in the second column.

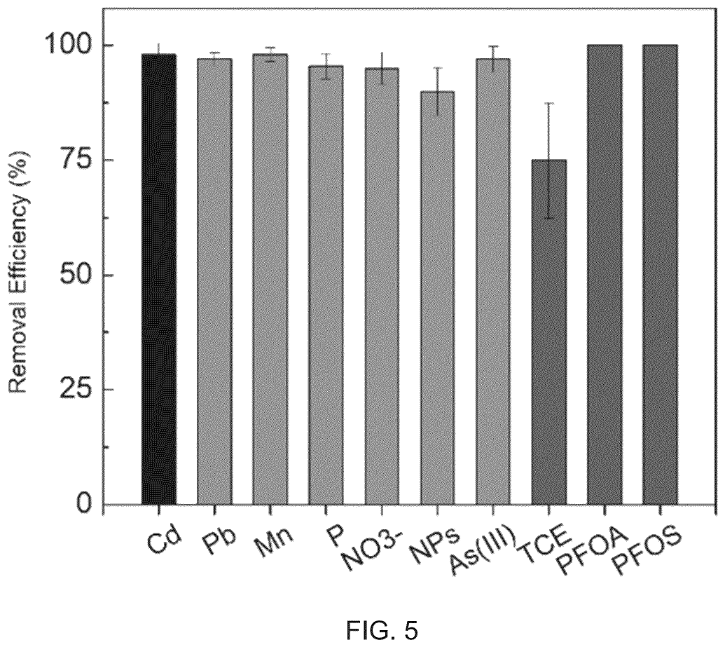

The electrochemical water purification system was tested by flowing three different influent compositions through the columns under a cell potential of 5.0 V. Acid washed zero valent iron particles (20×50 mesh) and washed granular activated carbon (20×50 mesh) were used as electrode materials. The first influent included 1 ppm 150 nm polystyrene particles, 1 ppm Pb²⁺, 1 ppm As(III), 1 ppm Cd²⁺, 5 ppm Mn²⁺, 2 ppm PO₄³⁻, 20 ppm NO₃²⁻, 1 ppm humic acid and 2 mM NaHCO₃. The second influent included 10 mg/L TCE in 20 mM NaCl. The third influent included 1 ug/L PFOA and PFOS in 5 mM NaCl. FIG. 5 is a graph showing the removal efficiency of the electrochemical water purification system for the various contaminants in these influent streams, within 10 pore volumes (PV, where 1 PV=8 min).

While the flowchart presented for this technology may imply a specific order of execution, the order of execution may differ from what is illustrated. For example, the order of two more blocks may be rearranged relative to the order shown. Further, two or more blocks shown in succession may be executed in parallel or with partial parallelization. In some configurations, one or more blocks shown in the flow chart may be omitted or skipped.

Reference was made to the examples illustrated in the drawings and specific language was used herein to describe the same. It will nevertheless be understood that no limitation of the scope of the technology is thereby intended. Alterations and further modifications of the features illustrated herein and additional applications of the examples as illustrated herein are to be considered within the scope of the description.

Furthermore, the described features, structures, or characteristics may be combined in any suitable manner in one or more examples. In the preceding description, numerous specific details were provided, such as examples of various configurations to provide a thorough understanding of examples of the described technology. It will be recognized, however, that the technology may be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements may be devised without departing from the spirit and scope of the described technology.

What is claimed is:

1. An electrochemical water purifier, comprising:
a water flow channel comprising a flow path for water to be treated; and
an electrochemical cell in the water flow channel comprising:
a first porous electrode comprising metal-containing particles, wherein the metal-containing particles comprise iron, zinc, nickel, or a combination thereof,
a second porous electrode comprising carbon-containing particles, wherein the flow path extends through the first porous electrode and the second porous electrode, and
a voltage source electrically connected to apply a voltage across the first porous electrode and the second porous electrode.

2. The electrochemical water purifier of claim 1, wherein the water flow channel comprises a packed column or wherein the water flow channel comprises a channel formed underground and wherein the water to be treated is groundwater.

3. The electrochemical water purifier of claim 2, wherein the water flow channel comprises the channel formed underground and wherein the flow path comprises a natural groundwater flow path.

4. The electrochemical water purifier of claim 1, wherein the first porous electrode is positively charged and the second porous electrode is negatively charged, or wherein the first porous electrode is negatively charged and the second porous electrode is positively charged.

5. The electrochemical water purifier of claim 1, wherein the first porous electrode is upstream of the second porous electrode with respect to the flow path.

6. The electrochemical water purifier of claim 1, wherein the metal-containing particles comprise Fe⁰, sulfidated Fe⁰, Fe₃O₄-coated Fe⁰, phosphate-coated Fe⁰, silicate coated Fe⁰, or a combination thereof.

7. The electrochemical water purifier of claim 1, wherein the carbon-containing particles comprise granular activated carbon.

8. The electrochemical water purifier of claim 1, wherein the metal-containing particles and the carbon-containing particles have a particle size less than 20 mesh.

9. The electrochemical water purifier of claim 1, wherein the voltage source is connected to the first and second porous electrodes by a coiled wire embedded in the first and second porous electrodes.

10. The electrochemical water purifier of claim 1, further comprising one or more porous supporting layers retaining the first porous electrode and the second porous electrode within the water flow channel.

11. The electrochemical water purifier of claim 10, wherein the one or more porous supporting layers comprise a film having a pore size of 200 mesh or smaller.

12. The electrochemical water purifier of claim 1, wherein the voltage source is configured to apply a voltage from 0 V to 20 V across the first porous electrode and the second porous electrode.

13. The electrochemical water purifier of claim 1, further comprising an aerator upstream of the electrochemical cell to aerate influent water to be treated.

14. An electrochemical water purification system, comprising:
a water flow channel comprising a flow path for water to be treated;
a first electrochemical cell in the water flow channel comprising a positive metal-containing porous electrode comprising metal-containing particles and a negative carbon-containing porous electrode comprising carbon-containing particles, wherein the flow path extends through the positive metal-containing porous electrode and the negative carbon-containing porous electrode;
a second electrochemical cell in the water flow channel comprising a negative metal-containing porous electrode comprising metal-containing particles and a positive carbon-containing porous electrode comprising carbon-containing particles, wherein the flow path extends through the negative metal-containing porous electrode and the positive carbon-containing porous electrode; and
one or more voltage sources connected to apply a voltage across the positive metal-containing porous electrode and the negative carbon-containing porous electrode, and to apply a voltage across the negative metal-containing porous electrode and the positive carbon-containing porous electrode.

15. The system of claim 14, wherein the first electrochemical cell is upstream of the second electrochemical cell with respect to the flow path.

16. The system of claim 14, wherein the positive metal-containing porous electrode is upstream of the negative carbon-containing porous electrode and wherein the negative metal-containing porous electrode is upstream of the positive carbon-containing porous electrode.

17. The system of claim 14, wherein the water flow channel comprises one or more packed columns or one or more channels formed underground.

18. The system of claim 14, wherein the one or more voltage sources allow independent control of the voltage across the positive metal-containing porous electrode and the negative carbon-containing porous electrode, and the voltage across the negative metal-containing porous electrode and the positive carbon-containing porous electrode.

19. A method of purifying water, comprising:
flowing water comprising a contaminant through a first porous electrode of an electrochemical cell, wherein the first porous electrode comprises metal-containing particles, wherein the metal-containing particles comprise iron, zinc, nickel, or a combination thereof;
flowing the water through a second porous electrode of the electrochemical cell, wherein the second porous electrode comprises carbon-containing particles;
applying a voltage across the first porous electrode and the second porous electrode; and
removing the contaminant from the water at the first porous electrode, at the second porous electrode, or a combination thereof.

20. The method of claim 19, wherein the contaminant comprises a polyfluoroalkyl substance (PFAS), a pathogen, a pharmaceutical, a nitrate, a heavy metal, a pesticide, a microplastic, a nanoplastic, or a combination thereof.

21. The method of claim 19, wherein the contaminant is removed by electrocoagulation, electroadsorption, oxidation, reduction, or a combination thereof.

22. The method of claim 19, further comprising aerating the water before flowing the water through the first porous electrode.

23. The method of claim 19, wherein the metal-containing particles comprise iron, wherein the method further includes dissolving iron at the first porous electrode and removing the contaminant at the second porous electrode by electrocoagulation or electroadsorption.

24. The method of claim 19, wherein the contaminant comprises a nitrate, and wherein the method further comprises converting the nitrate to ammonium at the first porous electrode and converting the ammonium to N₂ at the second porous electrode.

25. The method of claim 19, wherein the contaminant comprises a polyfluoroalkyl substance (PFAS) and wherein the PFAS is removed by electroadsorption at the second porous electrode.
